(19) United States
(12) Patent Application Publication
(10) Pub. No.: US 2025/0218671 A1
(43) Pub. Date: Jul. 3, 2025

(54) MULTILAYER ELECTRONIC COMPONENT

(71) Applicant: SAMSUNG ELECTRO-MECHANICS CO., LTD., Suwon-si (KR)

(72) Inventors: Kun Hoi Koo, Suwon-si (KR); Pum San Chae, Suwon-si (KR); Sang Won Choi, Suwon-si (KR); Ho Jae Lee, Suwon-si (KR)

(73) Assignee: SAMSUNG ELECTRO-MECHANICS CO., LTD., Suwon-si (KR)

(21) Appl. No.: 18/965,365

(22) Filed: Dec. 2, 2024

(30) Foreign Application Priority Data
Dec. 28, 2023 (KR) 10-2023-0195551

(51) Int. Cl. H01G 4/012; H01G 4/30

(52) U.S. Cl. CPC H01G 4/012; H01G 4/30

(57) ABSTRACT

A multilayer electronic component according to an example embodiment of the present disclosure may allow an electric field formed in a first direction between an internal electrode layer and a floating electrode layer to be formed in a second direction or a third direction to offset stress formed in a stress concentration region, thereby improving reliability, including BDV characteristics, of the multilayer electronic component.

### CROSS-REFERENCE TO RELATED APPLICATION(S)

This application claims benefit of priority to Korean Patent Application No. 10-2023-0195551 filed on Dec. 28, 2023, in the Korean Intellectual Property Office, the disclosure of which is incorporated herein by reference in its entirety.

### TECHNICAL FIELD

The present disclosure relates to a multilayer electronic component.

### BACKGROUND

A multilayer ceramic capacitor (MLCC), a multilayer electronic component, is a chip-type condenser, mounted on the printed circuit boards of various types of electronic products, such as image display devices including a liquid crystal display (LCD) and a plasma display panel (PDP), computers, smartphones and mobile phones, an on-board charger (OBC) of an electric vehicle, and circuits such as DC-DC converter, and serves to charge or electricity therein or discharge electricity therefrom.

When voltage is applied to a multilayer ceramic capacitor, stress may occur inside the multilayer ceramic capacitor due to an electrostriction phenomenon of a dielectric layer, which may cause a decrease in the reliability, including BDV characteristics, of the multilayer ceramic capacitor.

Conventionally, attempts have been made to alleviate the electrostriction phenomenon by introducing a floating electrode layer structure.

However, although the internal electrode structure introducing a general floating electrode layer may achieve an effect of alleviating the concentration of stress to some extent by entirely distributing a voltage, stress due to electrostriction may concentrate in corners at which electrode patterns of different polarities overlap each other in a stacking direction of the internal electrodes. Accordingly, even when introducing a floating electrode layer, BDV characteristics be or reliability may deteriorated, and this phenomenon may be further aggravated when operating the multilayer ceramic capacitor under high voltage.

Accordingly, in the internal electrode structure introducing the floating electrode layer, structural improvement is required to alleviate a phenomenon of stress concentration due to electrostriction in the corners in which the electrode patterns of different polarities overlap each other in the stacking direction of the internal electrode.

### SUMMARY

An aspect of the present disclosure is to alleviate the phenomenon of stress concentration due to electrostriction in corners at which electrode patterns of different polarities overlap each other in a stacking direction of an internal electrode, in an internal electrode structure introducing a floating electrode layer.

However, the aspects of the present disclosure are not limited to the above-described contents, and may be more easily understood in the process of describing specific embodiments of the present disclosure.

A multilayer electronic component according to an example embodiment of the present disclosure may include: a body including a dielectric layer and an internal electrode layer and a floating electrode layer alternately arranged in a first direction with the dielectric layer interposed therebetween, and including a first surface and a second surface opposing each other in the first direction, a third surface and a fourth surface connected to the first surface and the second surface and opposing each other in a second direction, and a fifth surface and a sixth surface connected to the first surface to the fourth surface and opposing each other in a third direction; and an external electrode disposed on the body, and the internal electrode layer may include a first electrode pattern connected to the third surface, and a second electrode pattern connected to the fourth surface and spaced apart from the first electrode pattern in the second direction, the floating electrode layer may include a third electrode pattern spaced apart from the third surface to the sixth surface, the first electrode pattern may include a first main portion and a first auxiliary portion spaced apart from the first main portion in the third direction on both sides of the first main portion in the third direction, the second electrode pattern may include a second main portion and a second auxiliary portion spaced apart from the second main portion in the third direction on both sides of the second main portion in the third direction, and the third electrode pattern may include a third main portion and a third auxiliary portion spaced apart from the third main portion in the third direction on both sides of the third main portion in the third direction.

One of the various effects of the present disclosure is to improve the reliability, including BDV characteristics, of a multilayer electronic component by controlling a shape of electrode patterns included in an internal electrode layer and a floating electrode layer and relieving the stress concentrating in corners at which electrode patterns having different polarities overlap each other in a stacking direction of the internal electrodes, in a multilayer electronic component including an internal electrode layer and a floating electrode layer.

Advantages and effects of the present disclosure are not limited to the foregoing content and may be more easily understood in the process of describing a specific example embodiment of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an example embodiment of the present disclosure and another example embodiment of the present disclosure;

FIG. 2 is a cross-sectional view taken along line I-I of FIG. 1;

FIG. 3 is a cross-sectional view taken along line II-II of FIG. 1;

FIG. 4 is a cross-sectional view taken along line III-III of FIG. 1;

FIG. 5A schematically illustrates a plan view of an internal electrode layer according to an example embodiment, and FIG. 5B schematically illustrates a plan view of a floating electrode layer according to an example embodiment;

FIG. 6A illustrates a region of an electrode pattern in which electrostriction stress is concentrated in a multilayer electronic component according to Comparative Example, and FIG. 6B illustrates a region of an electrode pattern in which electrostriction stress is concentrated in a multilayer electronic component according to Inventive Example; and

FIG. 7 schematically illustrates an exploded perspective view of a body according to an example embodiment.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. The example embodiments disclosed herein are provided for those skilled in the art to better explain the present disclosure. Therefore, in the drawings, the shapes and dimensions of elements may be exaggerated for clarity, and the same reference numerals will be used throughout to designate the same or like elements.

In addition, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. In addition, components with the same function within the same range of ideas are described using the same reference numerals. Throughout the specification, when a certain portion “includes” or “comprises” a certain component, this indicates that other components are not excluded and may be further included unless otherwise noted.

In the drawings, a first direction may be defined as a stacking direction or a thickness (T) direction, a second direction may be defined as a length (L) direction, and a third direction may be defined as a width (W) direction.

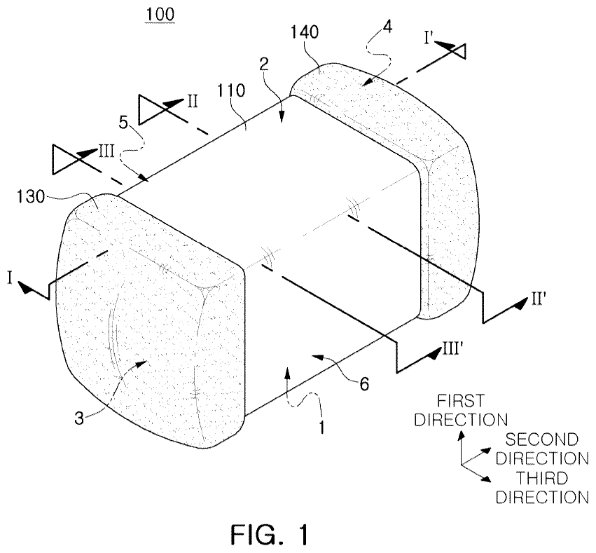

FIG. 1 schematically illustrates a perspective view of a multilayer electronic component according to an example embodiment of the present disclosure and another example embodiment of the present disclosure.

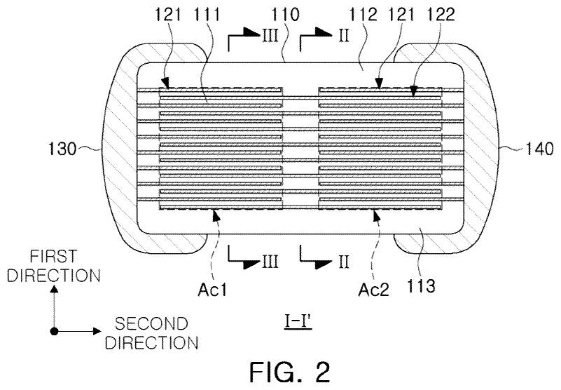

FIG. 2 is a cross-sectional view taken along line I-I of FIG. 1.

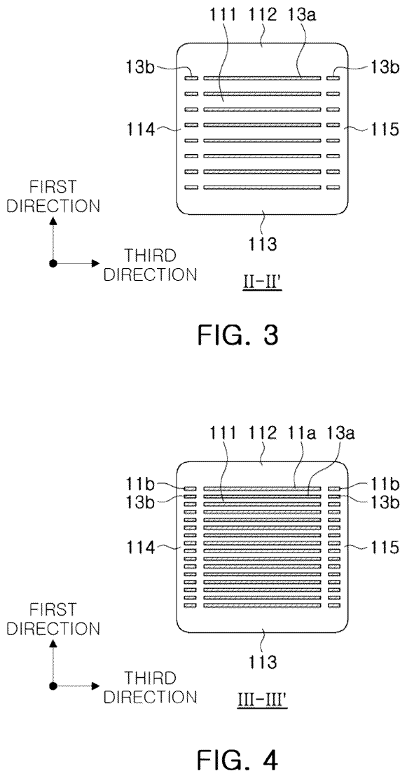

FIG. 3 is a cross-sectional view taken along line II-II of FIG. 1.

FIG. 4 is a cross-sectional view taken along line III-III of FIG. 1.

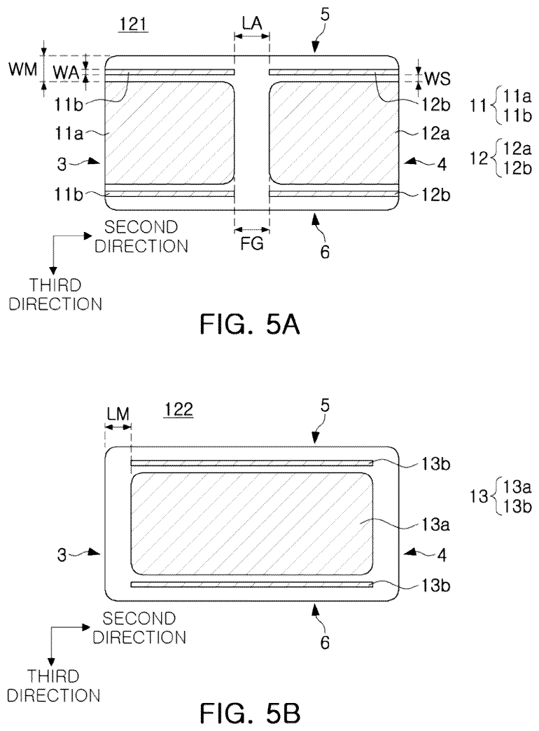

FIG. 5A schematically illustrates a plan view of an internal electrode layer according to an example embodiment, and FIG. 5B schematically illustrates a plan view of a floating electrode layer according to an example embodiment.

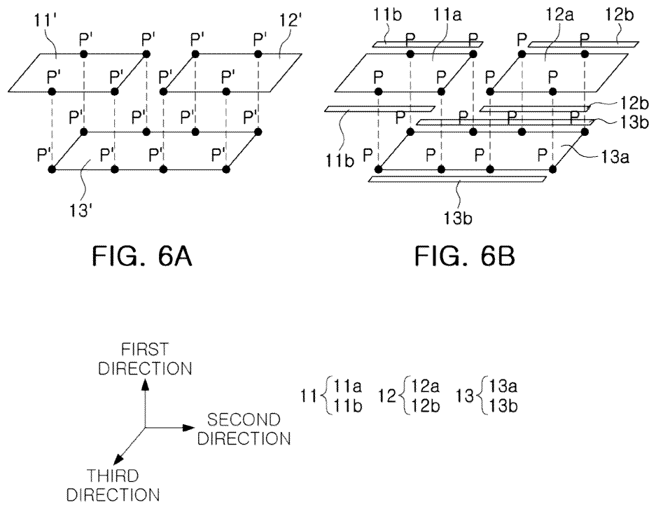

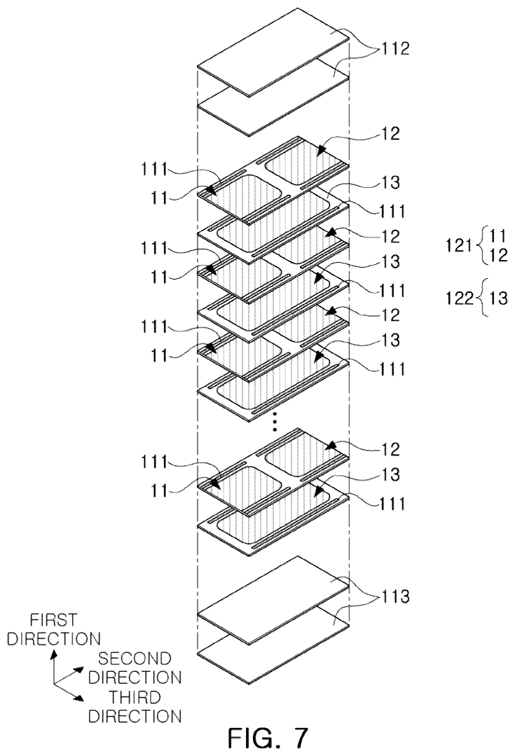

FIG. 6A illustrates a region of an electrode pattern in which electrostriction stress is concentrated in a multilayer electronic component according to Comparative Example, and FIG. 6B illustrates a region of an electrode pattern in which electrostriction stress is concentrated in a multilayer electronic component according to Inventive Example.

FIG. 7 schematically illustrates an exploded perspective view of a body according to an example embodiment.

Hereinafter, a multilayer electronic component 100 according to an example embodiment of the present disclosure and various embodiments thereof will be described in detail with reference to FIGS. 1 to 7. Additionally, a multilayered ceramic capacitor (hereinafter referred to as an ‘MLCC’) is described as an example of a multilayer electronic component, but the present disclosure is not limited thereto, and the multilayer electronic component of the present disclosure may also be applied to various multilayer electronic components using ceramic materials, such as inductors, piezoelectric elements, varistors, or thermistors.

A multilayer electronic component 100 according to an example embodiment of the present disclosure may include a body 110 including a dielectric layer 111 and an internal electrode layer 121 and a floating electrode layer 122 alternately disposed in a first direction with the dielectric layer interposed therebetween, and including first and second surfaces 1 and 2 opposing each other in the first direction, third and fourth surfaces 3 and 4 connected to the first and second surfaces and opposing each other in a second direction, perpendicular to the first direction, and fifth and sixth surfaces 5 and 6 connected to the first to fourth surfaces and opposing each other in a third direction, perpendicular to the first and second directions; and external electrodes 130 and 140 disposed on the body, and the internal electrode layer 121 may include a first electrode pattern 11 connected to the third surface, and a second electrode pattern 12 connected to the fourth surface and spaced apart from the first electrode pattern in the second direction, the floating electrode layer 122 may include a third electrode pattern 13 spaced apart from the third to sixth surfaces, the first electrode pattern may include a first main portion 11a and a first auxiliary portion 11b spaced apart from the first main portion in the third direction on both sides of the first main portion in the third direction, the second electrode pattern may include a second main portion 12a and a second auxiliary portion 12b spaced apart from the second main portion in the third direction on both sides of the second main portion in the third direction, and the third electrode pattern may include a third main portion 13a and a third auxiliary portion 13b spaced apart from the third main portion in the third direction on both sides of the third main portion in the third direction.

The body 110 may include a dielectric layer 111, an internal electrode layer 121, and a floating electrode layer 122.

More specifically, the body 110 may include a dielectric layer 111, and an internal electrode layer 121 and a floating electrode layer 122 alternately arranged in the first direction with the dielectric layer 111 interposed therebetween.

A specific shape of the body 110 is not particularly limited, but as illustrated, the body 110 may have a hexahedral shape or a shape similar thereto. Due to contraction of ceramic powder particles included in the body 110 during a sintering process, the body 110 may not have a hexahedral shape with entirely straight lines but may substantially have a hexahedral shape.

The body 110 may include the first and second surfaces 1 and 2 opposing each other in the first direction, the third and fourth surfaces 3 and 4 connected to the first and second surfaces 1 and 2 and opposing each other in the second direction, and fifth and sixth surfaces 5 and 6 connected to the first to fourth surfaces and opposing each other in the third direction.

In the present disclosure, the first direction may refer to a direction in which the internal electrode layer 121 and the floating electrode layer 122 are disposed with interposed therebetween, that is, the dielectric layer 111 a stacking direction of the internal electrode layer 121, the floating electrode layer 122, and the dielectric layer 111. The second direction may refer to a direction, perpendicular to the first direction, and the third direction may refer to a direction, perpendicular e first direction and the second direction simultaneously.

As margin regions in which the electrode pattern is not disposed on the dielectric layer 111 overlap each other, a step portion may occur due to a thickness of the internal electrode layer, and accordingly, a corner connecting the first surface and the third to fifth surfaces and/or a corner connecting the second surface and the third to fifth surfaces may have a shape contracted toward the center of the body 110 in the first direction based on the first surface or the second surface. Alternatively, due to a contraction behavior during a sintering process of the body, a corner connecting the first surface 1 and the third to sixth surfaces 3, 4, 5 and 6 and/or a corner connecting the second surface 2 and the third to sixth surfaces 3, 4, 5 and 6 may have a shape contracted toward a first directional center of the body 110 on based the first surface or the second surface. Alternatively, in order to prevent a chipping defect, a corner connecting each surface of the body 110 may be rounded by performing a separate process, so that the corner connecting the first surface and the third to sixth surfaces and/or the corner connecting the second surface and the third to sixth surfaces may have a round shape.

The dielectric layers 111 forming the body 110 may be formed in plural, and in a state in which a plurality of dielectric layers 111 are sintered, boundaries between adjacent dielectric layers 111 may be integrated to such an extent as to be difficult to identify without using a scanning electron microscope (SEM). The number of stacked dielectric layers 111 is not particularly limited, and may be determined in consideration of the size of the multilayer electronic component. For example, 400 or more dielectric layers may be stacked to form a body.

The dielectric layer 111 may be formed by producing a ceramic slurry containing ceramic powder particles, an organic solvent and a binder, applying and drying the slurry on a carrier film to prepare a ceramic green sheet, and then sintering the ceramic green sheet. The ceramic powder particles are not particularly limited as long as sufficient electrostatic capacitance may be obtained therewith, and for example, barium titanate-based (BaTiO₃) powder particles may be used as the ceramic powder particles. For more specific examples, the ceramic powder particles may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), and Ba(Ti_{1-y}Zr_{y})O₃ (0<y<1).

When barium titanate (BaTiO₃)-based powder particles are used as a raw material for forming the dielectric layer 111, the dielectric layer 111 after sintering may include Ba and Ti.

An average thickness of the dielectric layer 111 is not particularly limited.

In order to implement miniaturization and high capacitance of the multilayer electronic component 100, an average thickness td of the dielectric layer 111 may be 0.35 μm or less, and in order to improve reliability of the multilayer electronic component 100 under high temperature and high pressure, an average thickness of the dielectric layer 111 may be 20 μm or more.

An average thickness of the dielectric layer 111 may be measured by scanning an image of the third and first directional cross-section (L-T cross-sections) of the body 110 with a scanning electron microscope (SEM).

For example, with respect to a total of five dielectric layers, two layers to an upper portion and two layers to a lower portion based on a first layer of the dielectric layer at a point at which a longitudinal center line of the body meets a thickness-direction center line thereof among the dielectric layers extracted from an image of a length and thickness direction (L-T) cross-section obtained by cutting a center of the body 110 in a width direction scanned by the scanning electron microscope (SEM), an average thickness of the dielectric layer 111 may be measured by setting, to equal intervals, five points, that is, two points to the left and two points to the right, centered on the one reference point and then measuring thicknesses of each point, based on the point at which the longitudinal center line of the body meets the thickness-direction center line thereof.

When a voltage is applied to the multilayer electronic component 100, deformation such as contraction and expansion of the multilayer electronic component 100 may occur due to an electrostriction phenomenon in the material of the dielectric layer. The electrostriction phenomenon may be further intensified when a high voltage is applied to the multilayer electronic component 100 or when BaTiO₃ is used as a material for the dielectric layer.

On the other hand, when the voltage is applied to the multilayer electronic component 100, a deformation may occur in which the multilayer electronic component 100 may be expanded in the first direction, and may be contracted in the second direction and the third direction to form an electric field in the first direction. Additionally, the stress caused by the deformation of the multilayer electronic component 100 may be concentrated on a boundary between a region in which electrostatic capacitance is formed and a region in which the electrostatic capacitance is not formed, which may act as a cause of generating cracks in the multilayer electronic component 100.

Referring to FIG. 5A, the internal electrode layer 121 may include a first electrode pattern 11 connected to the third surface 3, and a second electrode pattern 12 connected to the fourth surface 4 and spaced apart from the first electrode pattern 11 in the second direction.

Referring to FIG. 6B, the floating electrode layer 122 may include a third electrode pattern 13 spaced apart from the third surface to the sixth surface 3, 4, 5 and 6.

Accordingly, as illustrated in FIG. 2, the body 110 may include capacitance forming portions Ac1 and Ac2 in which the internal electrode layer 121 and the floating electrode layer 122 overlap each other in the first direction, and the capacitance formation portions Ac1 and Ac2 may include a first capacitance formation portion Ac1 in which the first electrode pattern 11 and the third electrode pattern 13 overlap each other in the first direction, and a second capacitance formation portion Ac2 in which the second electrode pattern 12 and the third electrode pattern 13 overlap each other in the first direction. In this case, since the first electrode pattern 11 and the second electrode pattern 12 are spaced apart from each other in the second direction, the first capacitance formation portion Ac1 and the second capacitance formation portion Ac2 may be spaced apart from each other.

Since such a structure corresponds to a structure in which a plurality of capacitors are connected to each other in series and then connected in parallel again as a whole, it may be possible to obtain the effect of distributing voltage, from which an electrostriction phenomenon of the multilayer electronic component may be alleviated.

Referring to FIG. 7, the body 110 may be formed by repeatedly stacking the internal electrode layer and the floating electrode layer in the first direction with the dielectric layer 111 therebetween. Cover portions 112 and 113 may be disposed on an upper surface and a lower surface of a region, in the first direction, in which the internal electrode layer and the floating electrode layer are repeatedly stacked in the first direction with the dielectric layer 111 therebetween.

A material forming the internal electrode layer 121 and the floating electrode layer 122 is not particularly limited, and the material having excellent electrical conductivity may be used. For example, the internal electrode layer 121 and the floating electrode layer 122 may include one or more of nickel (Ni), copper (Cu), palladium (Pd), silver (Ag), gold (Au), platinum (Pt), tin (Sn), tungsten (W), titanium (Ti), and alloys thereof.

Each of the internal electrode layer 121 and the floating electrode layer 122 may be formed by printing a conductive phase on a ceramic green sheet, and the printing method may be a screen-printing method or a gravure printing method, but the present disclosure is not limited thereto.

A thickness of the internal electrode layer and the floating electrode layer is not particularly limited.

In order to implement miniaturization and high capacitance of the multilayer electronic component 100, an average thickness of the internal electrode layer and the floating electrode layer may be 0.35 μm or less, and in order to improve reliability of the multilayer electronic component 100 under high temperature and high pressure, the average thickness of the internal electrode layer and the floating electrode layer may be 3 μm or more.

A method of measuring the average thickness of the internal electrode layer and the floating electrode layer is not particularly limited. For example, with respect to a total of five dielectric layers, two layers to an upper portion and two layers to a lower portion based on a first layer of the internal electrode layer at a point at which a longitudinal center line of each of the capacitance formation portions Ac1 and Ac2 meets a thickness-direction center line thereof among the internal electrode layers extracted from an image of a width and thickness direction (W-T) cross-section obtained by cutting a center of the body 110 in a length direction scanned by the scanning electron microscope (SEM), an average thickness of the internal electrode layer may be measured by setting, to equal intervals, five points, that is, two points to the left and two points to the right, centered on the one reference point and then measuring thicknesses of each point, based on the point at which the longitudinal center line of each of the capacitance formation portions Ac1 and Ac2 meets the thickness-direction center line thereof.

Referring to FIG. 2, the body 110 may include cover portions 112 and 113 disposed in an upper portion and a lower portion of the first capacitance formation portion Ac1 and the second capacitance formation portion Ac2 in the first direction.

The cover portions 112 and 113 may be formed by stacking a single dielectric layer or two or more dielectric layers on upper and lower surfaces of the first capacitance formation portion Ac1 and the second capacitance formation portion Ac2 in a thickness direction, respectively, and may basically serve to prevent damage to the internal electrode due to physical or chemical stress.

The cover portions 112 and 113 do not include an electrode pattern, and may include a dielectric layer 111 and a dielectric material. That is, the cover portions 112 and 113 may include a ceramic material, and may include, for example, a barium titanate (BaTiO₃)-based ceramic material.

Thicknesses of the cover portions 112 and 113 need not be particularly limited. For example, an average thickness of the cover portions 112 and 113 may be 10 to 300 μm. The average thickness of the cover portions 112 and 113 may be an average value of first directional sizes of the cover portions 112 and 113 measured at five points equally spaced apart from each other in the upper portion and the lower portion the first capacitance formation portion Ac1 and the second capacitance formation portion Ac2.

Margin portions 114 and 115 may be disposed on side surfaces of the first capacitance formation portion Ac1 and the second capacitance formation portion Ac2.

Referring to FIG. 4, the margin portions 114 and 115 may be disposed on both end surfaces in a width direction of the body 110.

As illustrated in FIGS. 3 and 4, the margin portions 114 and 115 may refer to a region between both ends of the first and second main portions 11a and 12a in the third direction and a boundary surface of the body 110, or may mean an area between both ends of the third main portion 13a in the third direction and the boundary surface of the body 110, in a cross-section obtained by cutting the body 110 in the width-thickness (W-T) direction.

The margin portions 114 and 115 may serve to prevent damage to the internal electrode due to physical or chemical stress.

The margin portions 114 and 115 may be formed by forming a main portion of the first to third electrode patterns by applying a conductive paste except for a region in which the margin portion is to be formed on the ceramic green sheet, and forming an auxiliary portion in the region in which the margin portion is to be formed.

A width of the margin portions 114 and 115 does not need to be specifically limited. For example, the width of the margin portions 114 and 115 may be 5 μm or more, and when the multilayer electronic component is 3225 size or more, the width of the margin portions 114 and 115 may be 300 μm or more.

An average width of the margin portions 114 and 115 may refer to an average size of a region, in the third direction, in which the internal electrode is spaced apart from the fifth surface, and an average size of a region, in the third direction, in which the internal electrode is spaced apart from the sixth surface, and may be an average value of third directional sizes of the margin portions 114 and 115 measured at five points equally spaced apart from each other on side surfaces of the first capacitance formation portion Ac1 and the second capacitance formation portion Ac2.

The external electrodes 130 and 140 may be disposed on the third surface 3 and the fourth surface 4 of the body 110.

The external electrodes 130 and 140 may include first and second external electrodes 130 and 140 disposed on the third and fourth surfaces 3 and 4 of the body 110, respectively, and connected to the first and second electrode patterns 11 and 12, respectively. Specifically, the first external electrode 130 may be disposed on the third surface 3 and connected to the first electrode pattern 11, and the second external electrode 140 may be disposed on the fourth surface 4 and connected to the second electrode pattern 12.

In this example embodiment, a structure in which a multilayer electronic component 100 has two external electrodes 130 and 140 is described, but the number or shape of the external electrodes 130 and 140 may be changed depending on the shape of the internal electrode layer or other purposes.

The external electrodes 130 and 140 may be formed using any material as long as the material has electrical conductivity, such as a metal, and a specific material thereof may be determined in consideration of electrical characteristics, structural stability, or the like, and further, the external electrodes 130 and 140 may have a multilayer structure.

For example, the external electrodes 130 and 140 may include an electrode layer disposed on the body 110 and a plating layer formed on the electrode layer.

For a more specific example of the electrode layer, the electrode layer may be a sintered electrode including a conductive metal and glass, or a resin-based electrode including the conductive metal and a resin.

Additionally, the electrode layer may be in a form in which the sintered electrode and the resin electrode are sequentially formed on the body. Additionally, the electrode layer may be formed by transferring a sheet including a conductive metal onto the body, or may be formed by transferring a sheet including the conductive metal onto the sintered electrode. Additionally, the electrode layer may be formed as a plating layer, or may be a layer formed using a sputtering method or a deposition method such as Atomic layer deposition (ALD).

A material having excellent electrical conductivity may be used as the conductive metal included in the electrode layer, and is not particularly limited. For example, the conductive metal may be one or more of nickel (Ni), copper (Cu), and alloys thereof.

The plating layer serve to improve the mounting characteristics. The type of the plating layer is not particularly limited, and may be a plating layer including one or more of Ni, Sn, Pd, and alloys thereof, and may be formed of a plurality of layers.

For a more specific example of the plating layer, the plating layer may be a Ni plating layer or a Sn plating layer, and may be in a form in which the Ni plating layer and the Sn plating layer are sequentially formed on the electrode layer and may be in a form in which the Sn plating layer, the Ni plating layer and the Sn plating layer are sequentially formed. Additionally, the plating layer may include a plurality of Ni plating layers and/or a plurality of Sn plating layers. Additionally, the plating layer may be in a form in which the Ni plating layer and the Pd plating layer are sequentially formed on the electrode layer.

A size of the multilayer electronic component 100 does not need to be particularly limited. According to the present disclosure, since it is advantageous to achieve miniaturization and high capacitance, the multilayer electronic component 100 may be applied to a size of a small-sized IT product, and since the multilayer electronic component 100 is able to secure high reliability in various environments, it may be applied to a size of an automotive electrical product requiring high reliability.

Referring to FIG. 6A, the internal electrode layer and the floating electrode layer of the multilayer electronic component according to Comparative Example include electrode patterns 11′, 12′ and 13′ including only a main portion without disposing a separate auxiliary portion.

In this case, when a voltage is applied, stress may be concentrated at a corner in which the internal electrode patterns having different polarities overlap each other, and a region at which the stress is concentrated is indicated as P′ in FIG. 6A.

When the voltage is applied to the multilayer electronic component according to Comparative Example, an electric field is formed in the first direction in a region in which the first pattern 11′ and the third pattern 13′ overlap each other in the first direction, and an electric field is formed in the first direction in a region in which the second pattern 12′ and the third pattern 13′ overlap in the first direction. Accordingly, in the multilayer electronic component, stress concentration region P′ may be formed by concentrating on a boundary surface between the capacitance formation portion and the margin portion and a boundary surface between the capacitance formation portion and a capacitance non-formation portion.

Referring to FIG. 6B, the multilayer electronic component according to Inventive Example includes an internal electrode layer including a first electrode pattern 11 and a second electrode pattern 12 spaced apart from each other in the third direction, and a floating electrode layer 122. In FIG. 6B, the illustration of the dielectric layer disposed between the internal electrode layer and the floating electrode layer is omitted.

In FIG. 6B, the stress concentration region is indicated as P. In the multilayer electronic component 100 according to an example embodiment of the present disclosure, an electric field formed between the internal electrode layer 121 and the floating electrode layer 122 in the first direction may also be formed in the second or third direction, thereby offsetting the stress acting on the stress concentration region P indicated in FIG. 6B.

Specifically, referring to FIG. 6B, the first electrode pattern 11 included in the internal electrode layer of the multilayer electronic component 100 according to an example embodiment of the present disclosure may include a first main portion 11a and a first auxiliary portion 11b spaced apart from the first main portion 11a in the third direction on both sides of the first main portion 11a in the third direction, the second electrode pattern 12 may include a second main portion 12a and a second auxiliary portion 12b spaced apart from the second main portion 12a in the third direction on both sides of the second main portion 12a in the third direction, and the third electrode pattern may include a third main portion 13a and a third auxiliary portion 13b spaced apart from the third main portion 13a in the third direction on both sides of the third main portion 13a in the third direction, thus forming electric fields of the second and third directional components in the stress concentration region P. Accordingly, as compared to the conventional case in which tensile stress is concentrated in the first direction and compressive stress is concentrated in the second and third directions, some compressive stress may be generated in the first direction and some tensile stress may be generated in the second and third directions, so that the stress acting on the stress concentration region P illustrated in FIG. 6B may be offset to improve the reliability, including BDV characteristics, of the multilayer electronic component 100.

In an example embodiment, the first auxiliary portion 11b may be connected to the third surface 3, and the second auxiliary portion 12b may be connected to the fourth surface 4. Accordingly, an electric field in the second direction may also be formed between the first auxiliary portion 11b and the second auxiliary portion 12b, thereby further improving an effect of offsetting the stress acting on the stress concentration region.

In an example embodiment, each of a separation distance between the first main portion 11a and the first auxiliary portion 11b in the third direction, a separation distance between the second main portion 12a and the second auxiliary portion 12b in the third direction, and a separation distance WS between the third main portion 13a and the third auxiliary portion 13b in the third direction may be 100 μm or more and 200 μm or less.

When each of the separation distance between the first main portion 11a and the first auxiliary portion 11b in the third direction, the separation distance between the second main portion 12a and the second auxiliary portion 12b in the third direction, and the separation distance between the third main portion 13a and the third auxiliary portion 13b in the third direction is less than 100 μm, a problem in which the auxiliary portion and the main portion overlap each other may occur due to printing blur, and when each of the separation distance between the first main portion 11a and the first auxiliary portion 11b in the third direction, the separation distance between the second main portion 12a and the second auxiliary portion 12b in the third direction, and the separation distance between the third main portion 13a and the third auxiliary portion 13b in the third direction is more than 200 μm, the problem of reduced capacitance may occur.

Accordingly, in an example embodiment, each of the separation distance between the first main portion 11a and the first auxiliary portion 11b in the third direction, the separation distance between the second main portion 12a and the second auxiliary portion 12b in the third direction and the separation distance WS between the third main portion 13a and the third auxiliary portion 13b in the third direction may be adjusted to be 100 μm or more and 200 μm or less, thereby preventing the problem of reduced capacitance of the multilayer electronic component 100 and the problem in which the auxiliary portion and the main portion overlap each other.

In an example embodiment, a ratio of a width WA of the first and second auxiliary portions 11b and 12b in the third direction to a width WM in the third direction between third directional ends of the first and second main portions 11a and 12a and the fifth and sixth surface 5 and 6 may satisfy ⅛ or more and ⅓ or less.

In an example embodiment, the first auxiliary portion 11b and the second auxiliary portion 12b may be spaced apart from each other in the second direction, and thus, the first auxiliary portion 11b and the second auxiliary portion 12b may be electrically insulated from each other.

In an example embodiment, a length LA by which the first auxiliary portion 11b and the second auxiliary portion 12b are spaced apart from each other in the second direction may be substantially the same as a length FG by which the first main portion 11a and the second main portion 12a are spaced apart from each other in the second direction.

When the length FG by which the first main portion 11a and the second main portion 12a are spaced apart from each other in the second direction is excessively short, the stress compensation effect according to an example embodiment the present disclosure may be reduced.

Accordingly, the separation distance FG between the first main portion 11a and the second main portion 12a in the second direction and the separation distance LM between the third main portion 13a and the third surface 3 or the fourth surface 4 may satisfy LM>0.35FG.

When the third auxiliary portion 13b is not spaced apart from the third surface 3 and the fourth surface 4, the first external electrode 130 disposed on the third surface 3 and the second external electrode 140 disposed on the fourth surface 4 may be electrically connected to each other. Accordingly, in an example embodiment, the third auxiliary portion 13b may be spaced apart from the third surface 3 and the fourth surface 4, thereby preventing the first external electrode 130 and the second external electrode 140 from being electrically connected to each other.

In an example embodiment, the first auxiliary portion 11b, the second auxiliary portion 12b and the third auxiliary portion 13b may be spaced apart from the fifth surface 5 and the sixth surface 6. This may block a path through which external moisture may penetrate into the internal electrode layer 121 and the floating electrode layer 122, thereby improving the moisture resistance reliability of the multilayer electronic component 100.

In an example embodiment, a corner of the first main portion 11a, a corner of the second main portion 12a, and a corner of the third main portion 13a may have a rounded shape. Accordingly, the shape in which stress is concentrated at a specific position of the electrode pattern may be alleviated, thereby further improving the reliability improvement effect, including BDV characteristics, of the multilayer electronic component 100.

In an example embodiment, the dielectric layer 111 may include Ba and Ti. When the dielectric layer 111 is formed of a paraelectric dielectric corresponding to EIA Class 1, even if the voltage is applied, an electrostriction phenomenon may occur slightly or hardly occur. However, when the dielectric layer 111 is formed of a ferroelectric dielectric corresponding to EIA Class 2, for example, when the dielectric layer 111 includes Ba and Ti, deformation due to the electrostriction phenomenon may occur to a measurable extent, and this deformation may be a cause of stress generation inside the multilayer electronic component 100.

According to an example embodiment of the present disclosure, even when the dielectric layer 111 includes Ba and Ti, the stress applied to the region at which the stress is concentrated may be offset. That is, when the dielectric layer 111 includes Ba and Ti, the reliability improvement effect including BDV characteristics according to an example embodiment of the present disclosure may be further improved.

Although the example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ used in the present disclosure does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the terms are merely used to describe a specific embodiment, and are not intended to limit the present disclosure. Singular forms may include plural forms as well unless the context clearly indicates otherwise.

What is claimed is:

1. A multilayer electronic component, comprising:
a body including a dielectric layer and an internal electrode layer and a floating electrode layer alternately arranged in a first direction with the dielectric layer interposed therebetween, and including a first surface and a second surface opposing each other in the first direction, a third surface and a fourth surface connected to the first surface and the second surface and opposing each other in a second direction, and a fifth surface and a sixth surface connected to the first surface to the fourth surface and opposing each other in a third direction; and
an external electrode disposed on the body,
wherein the internal electrode layer includes a first electrode pattern connected to the third surface, and a second electrode pattern connected to the fourth surface and spaced apart from the first electrode pattern in the second direction,
the floating electrode layer includes a third electrode pattern spaced apart from the third, fourth, fifth and sixth surfaces,
the first electrode pattern includes a first main portion and a first auxiliary portion spaced apart from the first main portion in the third direction on both sides of the first main portion in the third direction,
the second electrode pattern includes a second main portion and a second auxiliary portion spaced apart from the second main portion in the third direction on both sides of the second main portion in the third direction, and
the third electrode pattern includes a third main portion and a third auxiliary portion spaced apart from the third main portion in the third direction on both sides of the third main portion in the third direction.

2. The multilayer electronic component according to claim 1, wherein the first auxiliary portion is connected to the third surface, and the second auxiliary portion is connected to the fourth surface.

3. The multilayer electronic component according to claim 1, wherein the first auxiliary portion and the second auxiliary portion are spaced apart in the second direction.

4. The multilayer electronic component according to claim 1, wherein the third auxiliary portion is spaced apart from the third surface and the fourth surface.

5. The multilayer electronic component according to claim 1, wherein the first auxiliary portion, the second auxiliary portion, and the third auxiliary portion are spaced apart from the fifth surface and the sixth surface.

6. The multilayer electronic component according to claim 1, wherein the body includes a first capacitance formation portion in which the first electrode pattern and the third electrode pattern overlap each other in the first direction, and a second capacitance formation portion in which the second electrode pattern and the third electrode pattern overlap each other in the first direction.

7. The multilayer electronic component according to claim 6, wherein the first capacitance formation portion and the second capacitance formation portion are spaced apart from each other in the second direction.

8. The multilayer electronic component according to claim 1, wherein a separation distance between the first main portion and the first auxiliary portion in the third direction is in a range from 100 μm to 200 μm,
a separation distance between the second main portion and the second auxiliary portion in the third direction is in a range from 100 μm to 200 μm and
a separation distance between the third main portion and the third auxiliary portion in the third direction is in a range from 100 μm to 200 μm.

9. The multilayer electronic component according to claim 1, wherein a ratio of a third directional width of the first and second auxiliary portions to a third directional separation between a third directional end of the first and second main portions and the fifth surface or the sixth surface is in a range from ⅛ to ⅓.

10. The multilayer electronic component according to claim 1, wherein when a separation distance between the first main portion and the second main portion in the second direction is defined as FG, and a separation distance between the third main portion and the third surface or the fourth surface is defined as LM,
LM>0.35FG is satisfied.

11. The multilayer electronic component according to claim 1, wherein a corner of the first main portion, a corner of the second main portion, and a corner of the third main portion have a rounded shape.

12. The multilayer electronic component according to claim 1, wherein the dielectric layer includes Ba and Ti.

13. The multilayer electronic component according to claim 1, wherein an average thickness of the dielectric layer is 20 μm or more.

14. A multilayer electronic component, comprising:
an internal electrode layer disposed in a body of the multilayer electronic component in a length-width plane and comprising:
a first electrode pattern comprising a first main portion and a first auxiliary portion spaced apart from the first main portion on both sides thereof in a width direction, the first main portion and the first auxiliary portion being exposed through a first side surface of the body, and
a second electrode pattern, spaced apart from the first electrode pattern in a length direction, and comprising a second main portion and a second auxiliary portion spaced apart from the second main portion on both sides thereof in the width direction, the second main portion and the second auxiliary portion being exposed through a second side surface of the body opposing the first side surface; and
a floating electrode layer spaced apart from the internal electrode layer in a thickness direction by a dielectric layer, and comprising a third main portion and a third auxiliary portion spaced apart from the third main portion on both sides thereof in the width direction, the floating electrode being spaced apart from all surfaces of the body.

15. The multilayer electronic component of claim 14, further comprising external electrodes disposed on the first and second side surfaces of the body and respectively connected to portions the first and second electrode patterns exposed therethrough.

16. The multilayer electronic component of claim 14, wherein the internal electrode layer and the floating electrode layer are spaced apart from thickness-wise opposing surfaces of the body by dielectric layers.
